(19) United States
(12) Patent Application Publication
(10) Pub. No.: US 2002/0091733 A1
(43) Pub. Date: Jul. 11, 2002

(54) System and method for dynamically generating tables of web pages

(76) Inventors: Tong S. Chen, Taipei (TW); Kuang Shin Lin, Taipei (TW)

Correspondence Address: BACON & THOMAS, 625 Slaters Lane - 4th Floor, Alexandria, VA, 22314-1176, US

(21) Appl. No.: 09/754,326

(22) Filed: Jan. 5, 2001

(51) Int. Cl. G06F 17/00

(52) U.S. Cl. 707/509; 707/513

(57) ABSTRACT

A system and method for dynamically generating tables used for web pages is disclosed. A form head manipulation module is employed in the embodiment to analyze the accessed web page information from a web page buffering unit. A table generation module is employed to generate custom-made tables by accompanying with user priorities and the text attributes of the table objects before showing the custom-made tables on web pages. A table style design module is also employed in the embodiment to receive selection commands from individuals to indicate whether table objects to be selected among the displayed ones. The table style design module then generates web pages included those selected tables to the individuals dynamically.

### BACKGROUND OF THE INVENTION

1. Field of the Invention

The present invention relates to a system and method for dynamically generating tables, and more particularly, to a system and method for dynamically generating tables for web pages according to different user priorities.

The present invention also relates to a system and method for dynamically generating tables for web pages having custom-made styles and contents according to specifications designed for achieving individual requirements.

2. Description of the Prior Art

The prosperous developments of the computer hardware and software technologies bring the modem world to be fast varied. Information exchanges more frequently than before, which brings a variety of information coded with different data types being generated and transferred each day for achieving different requirements. People can easily download desire information only by searching web servers or pages via portal sites and then by connecting their computer with web servers around the world through the Internet. Due to the prosperity of the network communications, a growing number of researchers have been devoted to the research of network technology, which significantly force the technologies and applications concerned with the Internet to have great progresses than before. This tendency also forces the owners of the web servers to frequently update contents and arrangements of their web pages for at least improving visual efficiency. One the other hand, modern enterprises become gradually internationalized, therefore an enterprise establishes bases in accompanied with branches around the world. For each branch, except for managing document information, it also has to share its own information with other branches through kinds of information exchange networks such as the Internet. To force individuals having different user priorities when inquiry or looking up the shared information thus becomes an important issue and a simplest scheme for achieving the purpose of maintaining information security.

The current technologies still lack of flexibility for generating web pages including tables. For example, most of the web pages do not set user priorities for constraining some information from being inquired when showing web pages with tables to different individuals. For system managers of the enterprises, to predefine user priorities may achieve the purpose of controlling information inquiry of databases, and various web page templates are then employed for filling inquiry data before forwarding the generated web pages to individuals. However, the above approaches can not vary contents or even styles of the web pages according to individual requirements. It remains a critical disadvantage for those prior art skills that have to modify table styles for including inquiry information as priorities or for continuing inquiry procedure by narrowing the inquiry information.

### SUMMARY OF THE INVENTION

The principal object of the invention is to provide a method and system for dynamically generating tables for web pages according to user priorities.

The other object of the invention is to provide a method and system for dynamically generating tables for web pages according to the table styles designed by different individuals.

In the preferred embodiment, a source object is used to read the form head information of the web page, while table objects with their information of the web page are then fetched by analyzing parameters in accompanied with values included in the form head. Web pages composed of tables, which are generated based on user priorities and the text attributes of the table objects, are then shown for individuals having different user priorities. Individuals may select table objects in web pages to further narrow inquiry scopes and the disclosed method will dynamically show the custom-made tables by using web pages.

The disclosed system basically encompasses a web page buffering unit, a form head manipulation module, a table generation module, and a table style design module. The web page buffering unit is a data buffering area for storing information from web pages or for receiving information that is going to be shown in web pages. The form head manipulation module receives the information from web pages for analyzing and processing the fetched information included in form heads of the web pages. The table generation module receives table information from the form head manipulation module for analyzing table information of the web pages. The web pages and the completed processed information by the table generation module are then forwarded to the web page buffering unit for showing purpose. The table style design module receives table information analyzed by the table generation module to dynamically generate custom-made tables in accompanied with selection commands from individuals. The custom-made tables are then forwarded to the table generation module before transferring to the web page buffering unit for showing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrative of the module configuration according to the present invention;

FIG. 2 is a flow diagram illustrative of the operating sequences when analyzing web page form heads according to the invention;

FIG. 3A is a flow diagram illustrative of the operating sequences when generating tables without custom-made ones;

FIG. 3B is a flow diagram illustrative of the operating sequences when displaying custom-made tables in web pages according to the invention;

FIG. 4 is a flow diagram illustrative of the operating sequences for designing table styles by selecting tables according to the invention;

FIG. 5A is a web page exemplary diagram according to the invention;

FIG. 5B is a web page exemplary diagram for showing tables generated by using the disclosed method and in accompanied with user priorities based on the web page of FIG. 5A, wherein portion fields of the displayed tables are selected; and

FIG. 5C is a web page exemplary diagram for showing table information according to the selected tables in FIG. 5B.

### DESCRIPTION OF THE PREFERRED EMBODIMENT

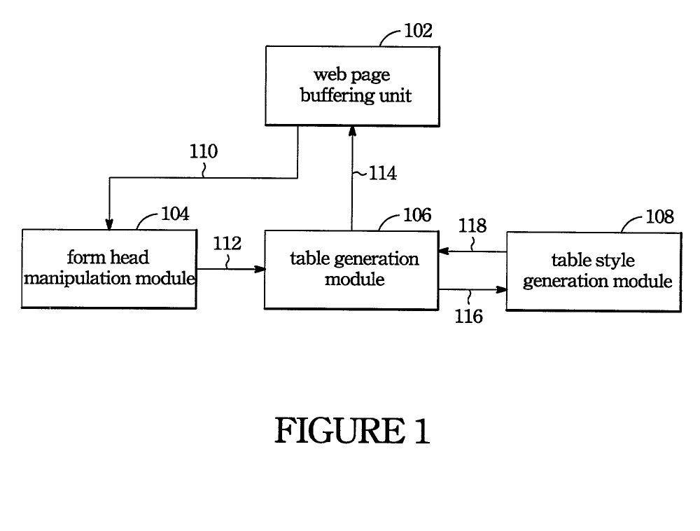

Please refer to FIG. 1, a schematic diagram of the preferred embodiment according to the invention is disclosed therein. A web page buffering unit 102 is a data buffer for receiving information from web pages or for receiving information for showing on web pages. A form head manipulation module 104 receives web page information from the web page buffering unit via the data flow 110 for analyzing form heads of the web pages. A table generation module 106 receives and then analyzes table information included within web pages from the form head manipulation module 104 via the data flow 112. The completed analyzed and processed information are then forwarded to the web page buffering unit 102 via the data flow 114 for showing purpose. A table style design module 108 also receives the analyzed information from the table generation module 106 via the data flow 116 for generating table having the styles designed according to the selection commands from individuals. The generated table styles are then forwarded back to the table generation module 106 via the data flow 118 for table generation purpose. The designed table styles are further forwarded to the web page buffering unit 102 for showing via the flow 114. Please note that the configuration of FIG. 1 is established in a client terminal. A server may generate data duplication stored in a client terminal for inquiry purpose by means of the data binding technology provided by DHTML (Dynamic Hyper Text Markup language).

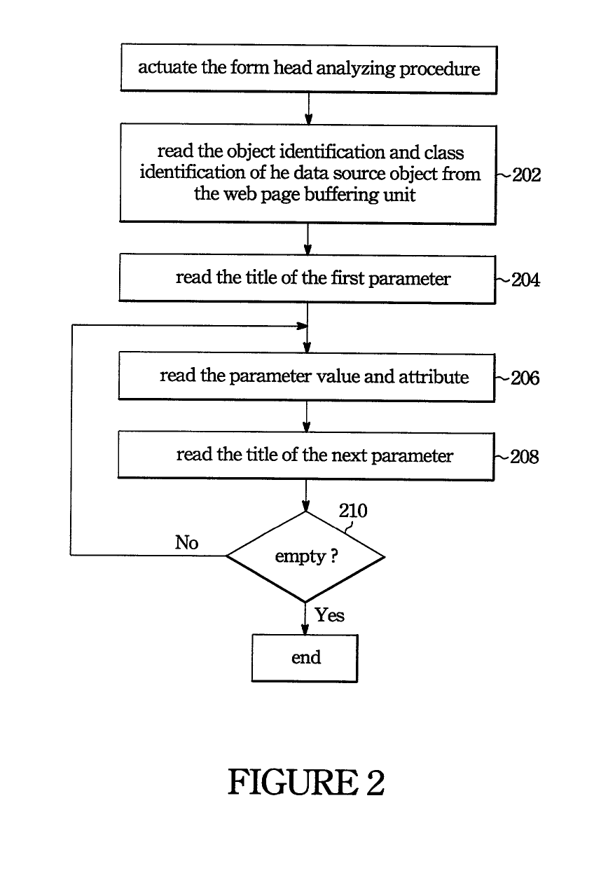

Please next refer to FIG. 2, a flow diagram for representing the operating sequences when analyzing form heads of the web pages is shown therein, which is also the principal flow of the form head manipulation module 104. In the embodiment, the DHTML configuration is used for explanation purpose but any similar configuration within the spirit of the embodiment should be included in the scope of the appended claims. Firstly, the form head manipulation module 104 receives web page information from the web page buffering unit 102 by means of a DSO (Data source object) approach, so that required object identification and class identification may be accessed by using DSO in block 202. For example, when describing a web page by means of DHTML under a Windows operating system (OS), form head information placed between the tag <OBJECT> and </OBJECT> will be accessed by DSO objects in block 202. The attribute and identification titles defined by the parameter “ID” and the class identification used for registering in the registry of Windows OS defined by the parameter “CLASSID” are also fetched at the same time. Next in blocks 204 and 206, the parameter title in accompanied with parameter value are then fetched from the form head, respectively. For example, the parameter title defined by “PARA” in DHTML will be accessed in block 204, and the associated parameter values are found followed by the “PARA” in block 206. The next parameter title is then fetched and determined whether the last one is accessed respectively in blocks 208 and 210. Functions in blocks 206˜210 will be repeated until all the parameters are read and manipulated. It is obvious that the objects, such as the DSO objects, embedded in web pages and connected between the computer browser and the web page viewer (e.g., HTML viewer) for transferring information bi-directions will be obtained after completing the above flow in FIG. 2.

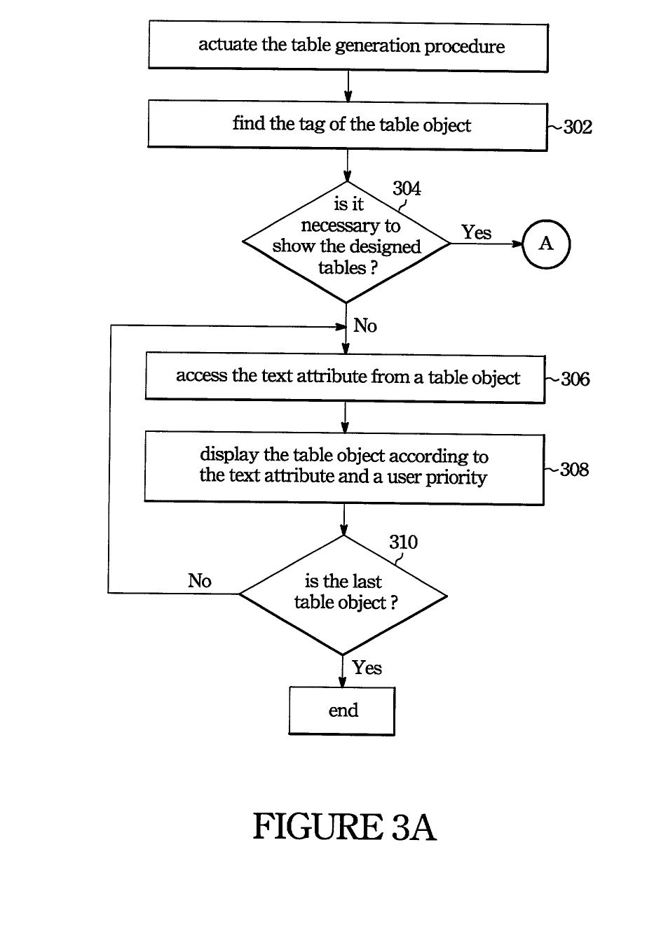

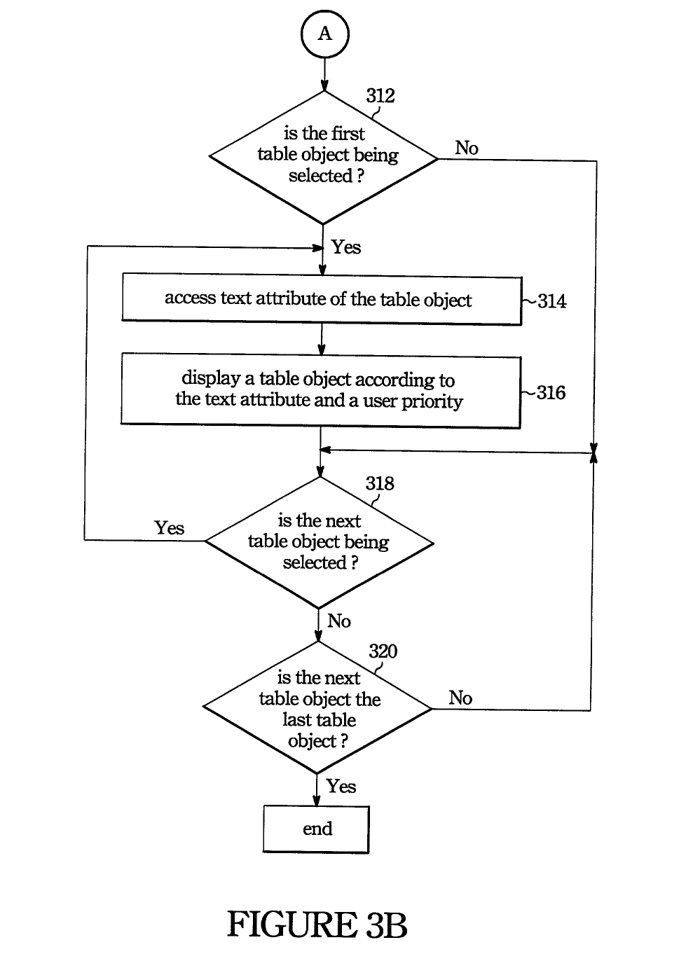

FIGS. 3A and 3B represent the flowchart for generating tables in the embodiment, which also show the main operating sequences of the table generation module 106. However, FIGS. 3A and 3B also demonstrate the operating flows for showing original and custom-made tables, respectively. The table generation module 106 firstly receives web page information and finds table object tags, for example in DHTML, the tag <TBODY> that is used to define table contents will be found in block 302. Next, the table generation module 106 decides whether the custom-made tables (i.e., tables designed by individuals) are shown in block 304. If there needs to show the custom-made tables, the operating flow will be redirected to FIG. 3B from the label A. Otherwise a text attribute (e.g., fonts or characters included in tables) of the table object will be accessed in block 306, and then the custom-made tables are generated also according to the user's priority in block 308. The appearances of the custom-made tables are decided by means of the definitions of the <SPAN> tag in block 310. Similarly, the functions in blocks 306˜310 are repeatedly performed until the last table object is manipulated.

Please next refer to FIG. 3B, a flowchart for showing the operating sequences of displaying the custom-made tables in the embodiment is shown therein. The table generation module 106 firstly detects if the first table object is selected in block 312. The text attribute as above-mentioned will be accessed in block 314 and those selected tables will be shown with reference to the user's priority in block 316 when the table object being selected. The next table object is then detected whether to be selected in block 318 and the consecutive table object is then detected to be the last table object in block 320 if the next object is not a selected one. Those functions in blocks 314˜320 are also repeatedly performed until the last table object is found and manipulated. If the first table object is not selected, the flow will be redirected to the block 318 for detecting the selection status of the second table object.

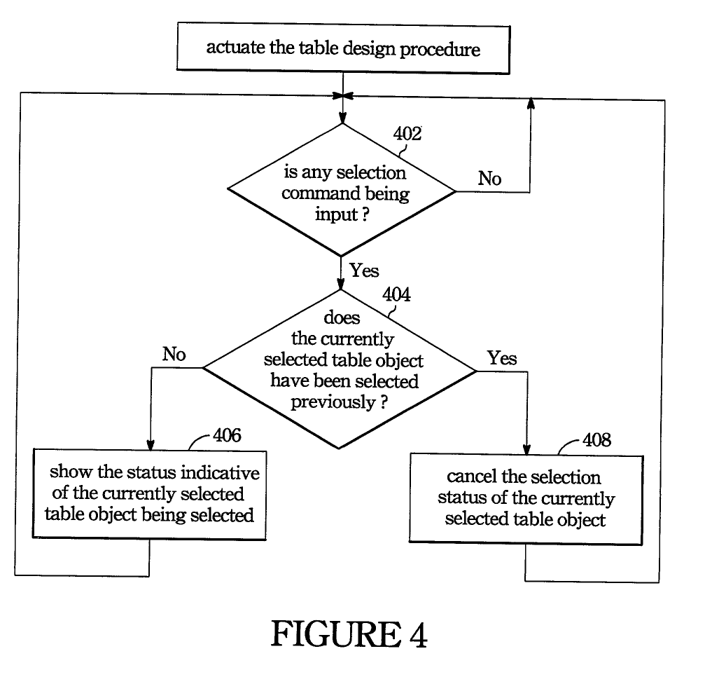

FIG. 4 illustrates a flowchart for designing tables in the embodiment, which also shows the principal operating sequences of the table style design module 108. Firstly, the table style design module 108 detects whether an individual have given a selection command in block 402, and the detecting procedure will be repeated if no command being given. Otherwise, the selected table object will be checked whether it has been selected previously in block 404. Of course the table object will show the status indicative of being selected if non-selected previously in block 406. As noted, the selection status will be cancelled in block 408 if the currently selected table object has been selected. Any input device or user interface such as mouse, track balls, or keyboards may be employed to receive the selection commands, and the aforementioned selection approach may be employed to the applications having multi-tables objects. An ordinary persons skilled in the art of the present invention should modify the embodiment as applications but all the similar arrangements within the spirit of the embodiment should be included in the appended claims.

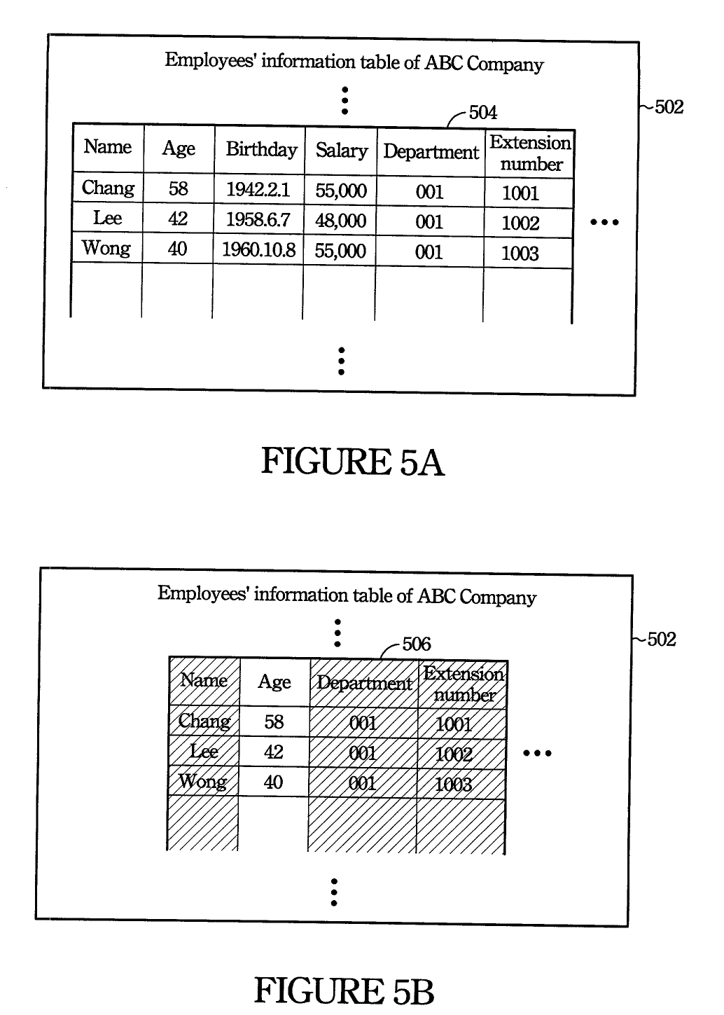

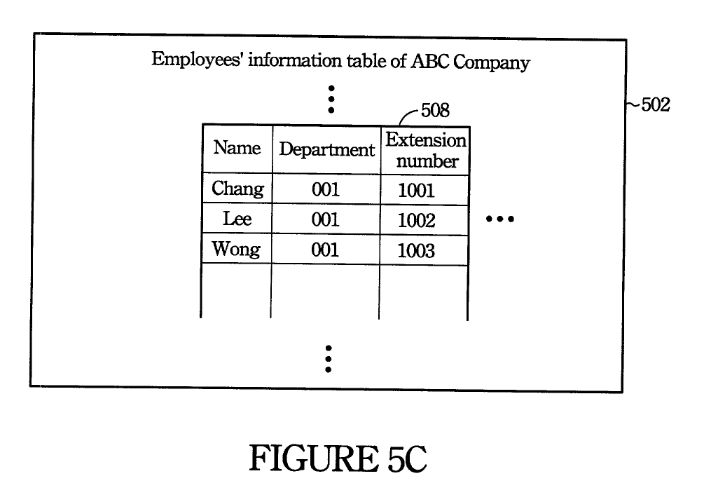

FIG. 5A to 5C show exemplary web pages when the embodiment being implemented. The web page 502 in FIG. 5A encompasses an employee information table 504 that further consists of each employee's name, age, birthday, salary, department, and extension number in an enterprise (the ABC Company). It is obvious to prevent the private information in the employees' information table 504 from publishing to every individual, for example, the employees' salary should be kept secret for arising unexpected side-effects. Controls for information inquiry therefore becomes an important issue for modern enterprises. When an administration assistant has to inquire for essential information of employees, the exemplary web page 502 will show the table 506 without the salary information to the administration assistant because of lower class. As noted, the table 506 is generated in the table generation module 106 by following the flow in FIG. 3A. Next, the administration assistant may click left button of his/her mouse to select tables to narrow current inquiry scopes. For example, when employees' names, departments, and extension numbers are selected in FIG. 5B, the selected information will be shown as the table 508 in FIG. 5C, wherein the table 508 may be generated by the table generation module 106 and in accompanied with the flow in FIG. 3B.

In conclusion, the present invention discloses a method and system for dynamically generating tables for web pages according to user priorities and designs. Any individual may design table styles as requirements or specifications to dynamically vary or narrow inquiry scopes in the derived table styles. The disadvantage that can not vary the table style and contents of the web pages can be significantly eliminated.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for dynamically generating tables for web pages, said method comprising the steps of:
analyzing a form head of a web page for accessing object information of a data binding object that is used to transfer information between said web page and a computer browser;
obtaining a text attribute of a table object included in said web page; and
displaying said table object in said web page by using said text attribute and a user priority.

2. The method according to claim 1, wherein said data binding object is embedded in said web page for transferring information.

3. The method according to claim 2, wherein said data binding object is a data source object derived from a dynamic hyper text markup language (DHTML).

4. The method according to claim 1, wherein said analyzing step comprises the steps of:
obtaining an object identification and a class identification of said data binding object;
obtaining a parameter title from said data binding object;
obtaining a parameter value for said parameter title; and
generating object information by using said object identification, said class identification, said parameter title, and said parameter value.

5. The method according to claim 1, wherein said text attribute comprises text contents and a font attribute.

6. The method according to claim 1, further comprising a method for varying displayed tables according to a selection command comprising the steps of:
inputting said selection command, wherein said selection command is used to indicate the selection status of said table object, or to cancel the selection status of said table object; and
displaying selected table objects in said web page by using said text attribute and said user priority.

7. A system for dynamically generating tables for web pages, wherein said system comprises:
form head manipulation means responsive to web page information for analyzing form head included in said web page information to obtain object information of a data binding object that is used to transfer information between said web page and a browser; and
table generation means responsive to said web page information for accessing a text attribute of a table object included in said web page and for displaying said table object in said web page by using said text attribute and a user priority.

8. The system according to claim 7, wherein said form head is analyzed by using a method comprising the steps of:
obtaining an object identification and a class identification of said data binding object;
obtaining a parameter title from said data binding object;
obtaining a parameter value for said parameter title; and
generating object information by using said object identification, said class identification, said parameter title, and said parameter value.

9. The system according to claim 7, wherein said data binding object is embedded in said web page for transferring information.

10 The system according to claim 9, wherein said data binding object is a data source object derived from a dynamic hyper text markup language (DHTML).

11. The system according to claim 7, wherein said text attribute comprises text contents and a font attribute.

12. The system according to claim 7, further comprising table style generating means responsive to a selection command for varying the status of said table objects.

13. The system according to claim 12, wherein said selection command is used for designating the selection status of said table object, or for canceling the selection status of said table object.

14. A computer-readable storage medium for storing a method for dynamically generating tables for web pages, wherein said computer-readable storage medium having computer executable instructions for performing steps comprising:
analyzing a form head of a web page for obtaining object information of a data binding object connected between said web page and a browser;
obtaining a text attribute of a table object included in said web page; and
displaying said table object in said web page by using said text attribute and a user priority.

15. The computer-readable storage medium according to claim 14, wherein said analyzing step comprises the steps of:
obtaining an object identification and a class identification of said data binding object;
obtaining a parameter title from said data binding object;
obtaining a parameter value for said parameter title; and
generating object information by using said object identification, said class identification, said parameter title, and said parameter value.

16. The computer-readable storage medium according to claim 14, wherein said data binding object is embedded in said web page for transferring information.

17. The computer-readable storage medium according to claim 16, wherein said data binding object is a data source object derived from a dynamic hyper text markup language (DHTML).

18. The computer-readable storage medium according to claim 14, wherein said text attribute comprises text contents and a font attribute.

19. The computer-readable storage medium according to claim 14, wherein said computer-readable storage medium having computer executable instructions for performing a method for varying displayed tables according to a selection command steps comprising:
inputting said selection command, wherein said selection command is used for designating the selection status of said table object, or for canceling the selection status of said table object; and
displaying selected table objects in said web page by using said text attribute and said user priority.
